(19) United States
(12) Patent Application Publication
(10) Pub. No.: US 2026/0017677 A1
(43) Pub. Date: Jan. 15, 2026

(54) SYSTEMS AND METHODS FOR FORECASTING SALES DATA OF NEW STORE ITEMS

(71) Applicant: Walmart Apollo, LLC, Bentonville, AR (US)

(72) Inventors: Lakshya Garg, New Brunswick, NJ (US); Mayank Uniyal, Bangalore (IN); Sujal Reddy Alugubelli, Bentonville, AR (US); Karthik Kumaran, Sunnyvale, CA (US); Rishi Bhatia, Bentonville, AR (US)

(21) Appl. No.: 18/769,676

(22) Filed: Jul. 11, 2024

(51) Int. Cl. G06Q 30/0202; G06Q 10/087; G06Q 30/0204

(52) U.S. Cl. CPC G06Q 30/0202; G06Q 10/087; G06Q 30/0204

(57) ABSTRACT

Systems and methods for forecasting sales data of items that are new or missing historical sales data at a physical retailer store are disclosed. In some embodiments, a disclosed method includes: receiving, from a computing device, a forecast request seeking sales data of an item if the item is offered for sale at a physical store in a future time period, wherein historical sales data of the item at the physical store is not available; determining, based on the forecast request, at least one relevant feature related to the item or the physical store; computing, based on a machine learning model and the at least one relevant feature, forecasted sales data of the item at the physical store in the future time period; and transmitting the forecasted sales data to the computing device.

### TECHNICAL FIELD

This application relates generally to store assortment optimization and, more particularly, to systems and methods for forecasting sales data of items that are new or missing historical sales data at a physical retailer store to refresh and optimize assortment at the store.

### BACKGROUND

Retailers can increase profits as sales increase. In some instances, as variety in product assortment increases, retailers may not stock the most beneficial assortment of goods to sell. Making right decisions on the product assortment in a retailer store, which caters effectively to future preferences and demands of consumers, is of paramount importance to the retailer, since it will often be a significant amount of time before changes to the product assortment can be implemented.

While a retailer may want to refresh its in-store assortment with evolving ecommerce trends, selecting which item to bring to store from ecommerce and determining an expected demand or sales for the selected item for a given store are challenging, especially when there is no history of in-store sales for the novel ecommerce items, which is referred to as a store cold start forecasting problem. Existing methods for tackling the store cold start forecasting problem are prone to predicting all zero values in the output tensor during inference due to the sparsity of data present in the input tensor. In addition, existing methods can learn only linear relationships and cannot handle huge amounts of data.

### SUMMARY

The embodiments described herein are directed to systems and methods for forecasting sales data of items that are new or missing historical sales data at a physical retailer store, to refresh and optimize assortment at the physical retailer store.

In various embodiments, a system including a non-transitory memory configured to store instructions thereon and at least one processor is disclosed. The at least one processor is operatively coupled to the non-transitory memory and configured to read the instructions to: receive, from a computing device, a forecast request seeking sales data of an item if the item is offered for sale at a physical store in a future time period, wherein historical sales data of the item at the physical store is not available; determine, based on the forecast request, at least one relevant feature related to the item or the physical store; compute, based on a machine learning model and the at least one relevant feature, forecasted sales data of the item at the physical store in the future time period; and transmit the forecasted sales data to the computing device.

In various embodiments, a computer-implemented method is disclosed. The computer-implemented method includes: receiving, from a computing device, a forecast request seeking sales data of an item if the item is offered for sale at a physical store in a future time period, wherein historical sales data of the item at the physical store is not available; determining, based on the forecast request, at least one relevant feature related to the item or the physical store; computing, based on a machine learning model and the at least one relevant feature, forecasted sales data of the item at the physical store in the future time period; and transmitting the forecasted sales data to the computing device.

In various embodiments, a non-transitory computer readable medium having instructions stored thereon is disclosed. The instructions, when executed by at least one processor, cause at least one device to perform operations including: receiving, from a computing device, a forecast request seeking sales data of an item if the item is offered for sale at a physical store in a future time period, wherein historical sales data of the item at the physical store is not available; determining, based on the forecast request, at least one relevant feature related to the item or the physical store; computing, based on a machine learning model and the at least one relevant feature, forecasted sales data of the item at the physical store in the future time period; and transmitting the forecasted sales data to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for forecasting sales data of items that are new or missing historical sales data, in accordance with some embodiments of the present teaching;

FIG. 2 is a block diagram of a sales forecast computing device, in accordance with some embodiments of the present teaching;

FIG. 3 is a block diagram illustrating various portions of a system for forecasting sales data of items that are new or missing historical sales data, in accordance with some embodiments of the present teaching;

FIG. 4 illustrates exemplary stages for training and using a sales forecast model, in accordance with some embodiments of the present teaching;

FIG. 5 illustrates an exemplary structure of a sales forecast model, in accordance with some embodiments of the present teaching;

FIG. 6 shows a table illustrating exemplary features for determining similar stores, in accordance with some embodiments of the present teaching;

FIG. 7 shows a flowchart illustrating an exemplary method for forecasting sales data of items that are new or missing historical sales data, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

It is crucial for a store (e.g. a physical store or brick and mortar store) of a retailer to keep its assortment on store shelves relevant and being a good representation of customer demand for the items in the assortment, as the shelf space is very valuable for the retailer and lots of labor cost are involved in replenishing the shelf space and managing the supply chain accordingly. A new-to-store (NTS) item is an item that has no or missing sales history at a given store. Having an accurate sales forecast for an NTS item at a corresponding store is important for a retailer to determine and select items for assortment refresh at the corresponding store.

One objective of various embodiments in the present teaching is to develop systems and methods for sales data forecast, particularly for NTS items with the scarcity of historical data in stores. Assuming a retailer can always provide enough supply for an item given a demand forecast of the item, the demand forecast would be equivalent to a sales forecast for the item. As such, “demand forecast” and “sales forecast” will be used interchangeably in the present teaching.

In some embodiments, a disclosed system utilizes a demand forecast model to predict sales data of an item in a future time period (e.g. weekly sales in the next 104 weeks), if the item was introduced in a target store where the item was not previously being sold. This forecast will be consumed by a downstream optimization model to stack the right combination of items in the target stores and/or to provide a visualization of future demand for the introduced NTS item to merchants planning to launch the item in a specific store.

In some embodiments, while the NTS items lack the historical sales data in the target store where they would be introduced, the system utilizes other NTS item features such as: sales and availability data of the NTS item across similar stores; NTS item features such as brand name, item level description, product hierarchy description, product name, catalog identity, merchandise department and category; target store features; and demographic features of the NTS item and the target store. The system can leverage these and other attributes and use a customized feed forward deep neural network built based on tensor flow and some open-source library to forecast sales of the NTS item introduced at the target store for a future time period (e.g. weekly sales in 104 weeks post the introduction week). As such, the system can provide merchants with forecasted demand or sales data across all possible NTS item-store combination pairs. The accurate NTS forecast can be utilized by a store assortment model to arrive at the optimal set of assortment.

In some embodiments, the disclosed system leverages a feed forward deep neural network with an inverted structure, within which item, store, and sales features are passed at different depths to learn different information at each feed forward layer to tackle the store cold start forecasting problem. The disclosed system learns from both store-item interactions and sales interactions separately. Therefore, in case of receiving a sparse input sales vector, a disclosed forecast model still has a densely populated store-item interaction vector to predict non-zero sales.

In some embodiments, the disclosed forecast model uses a hierarchical deep learning network architecture which learns from many different features, which is much more capable than standard linear-autoregressive models. For example, the system can pass item, store, and sales features at different depths of the deep learning network to learn different information at each feed forward layer, thereby creating a hierarchical architecture. The item and store features may be learned through embedding layers and passed through feed forward layers of the deep learning network. Because both store-item interactions and sales interactions are learned, the network can output a non-zero output sales tensor even in case of sparsely populated input features.

Furthermore, in the following, various embodiments are described with respect to systems and methods for forecasting sales data of items that are new or missing historical sales data at a physical retailer store are disclosed. In some embodiments, a disclosed method includes: receiving, from a computing device, a forecast request seeking sales data of an item if the item is offered for sale at a physical store in a future time period, wherein historical sales data of the item at the physical store is not available; determining, based on the forecast request, at least one relevant feature related to the item or the physical store; computing, based on a machine learning model and the at least one relevant feature, forecasted sales data of the item at the physical store in the future time period; and transmitting the forecasted sales data to the computing device.

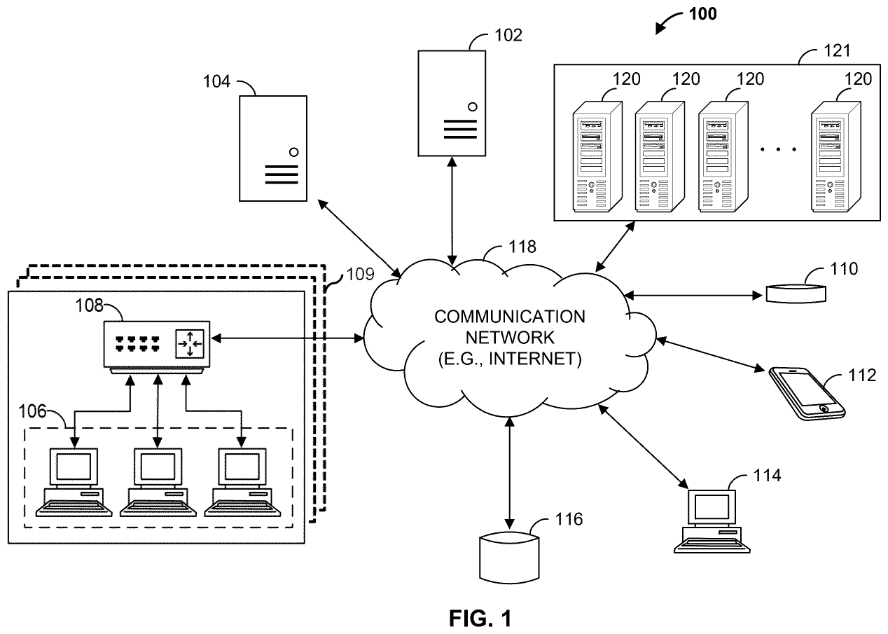

Turning to the drawings, FIG. 1 is a network environment 100 configured for forecasting sales data of items that are new or missing historical sales data at a physical retailer store, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a sales forecast computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The sales forecast computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the sales forecast computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the sales forecast computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the sales forecast computing device 102, the processing devices 120, and/or the server 104 are operated by a retailer, and the multiple user computing devices 110, 112, 114 are operated by merchants, associates, or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at one or more stores 109 of a retailer, for example. The workstation(s) 106 can communicate with the sales forecast computing device 102 over the communication network 118. The workstation(s) 106 may send data to, and receive data from, the sales forecast computing device 102. For example, the workstation(s) 106 may transmit data identifying items purchased by a customer at the one or more stores 109 to the sales forecast computing device 102. The workstation(s) 106 may also transmit other data related to the one or more stores 109 to the sales forecast computing device 102.

Although FIG. 1 illustrates three user computing devices 110, 112, 114, the network environment 100 can include any number of user computing devices 110, 112, 114. Similarly, the network environment 100 can include any number of the sales forecast computing devices 102, the processing devices 120, the workstations 106, the stores 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104.

In some embodiments, merchant of the retailer may operate one of the user computing devices 110, 112, 114 to access an application programming interface (API) hosted by the server 104. The merchant may, via the API, perform actions on existing or new items to a store of the retailer, to launch new products in of the store. For example, the merchant may search for new items, view item sales data in other stores, view corresponding item and store features, request a sales forecast for a new item for the store, compare forecasted sales of different new items, etc. The API may capture these activities as user session data, and transmit the user session data to the sales forecast computing device 102 over the communication network 118.

In some examples, the server 104 transmits to the sales forecast computing device 102 a forecast request seeking predicted sales data for an NTS item at a store in a future time period. In some examples, the sales forecast computing device 102 may execute one or more models (e.g., programs or algorithms), such as a machine learning model, deep learning model, statistical model, etc., to generate forecasted sales data for the NTS item. The sales forecast computing device 102 may determine one or more relevant features related to the item and/or the store. The sales forecast computing device 102 may compute, based on a machine learning model and at least one relevant feature can forecast sales data of the item at the store in the future time period.

In some embodiments, the sales forecast computing device 102 may directly generate, based on the forecasted sales data, recommended assortment data for the store in the future time period; and transmit the recommended assortment data to the server 104 for assortment refresh at the store. In some examples, both the forecasted sales data and the recommended assortment data are visually presented to a merchants, e.g. via a graphic user interface.

In some embodiments, the sales forecast computing device 102 is further operable to communicate with the database 116 over the communication network 118. For example, the sales forecast computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the sales forecast computing device 102, in some examples, the database 116 can be a local storage device, such as a hard drive, a non-volatile memory, or a USB stick. For example, the sales forecast computing device 102 may store online purchase data received from the server 104 in the database 116. The sales forecast computing device 102 may receive in-store purchase data and store related data from the one or more stores 109 and store them in the database 116.

In some examples, the sales forecast computing device 102 generates and/or updates different models (e.g., machine learning models, deep learning models, statistical models, algorithms, etc.) for forecasting sales data of items that are new or missing historical sales data at a physical retailer store. The sales forecast computing device 102 may generate training data for the models based on data including but not limited to: historical sales data, historical item availability data, generated synthetic sales data, data related to customers, items and stores, and inter-store relation data. The sales forecast computing device 102 trains the models based on their corresponding training data, and stores the models in a database, such as in the database 116 (e.g., a cloud storage). The models, when executed by the sales forecast computing device 102, allow the sales forecast computing device 102 to generate forecasted sales for NTS items.

In some examples, the sales forecast computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the sales forecast computing device 102 may generate forecasted sales data.

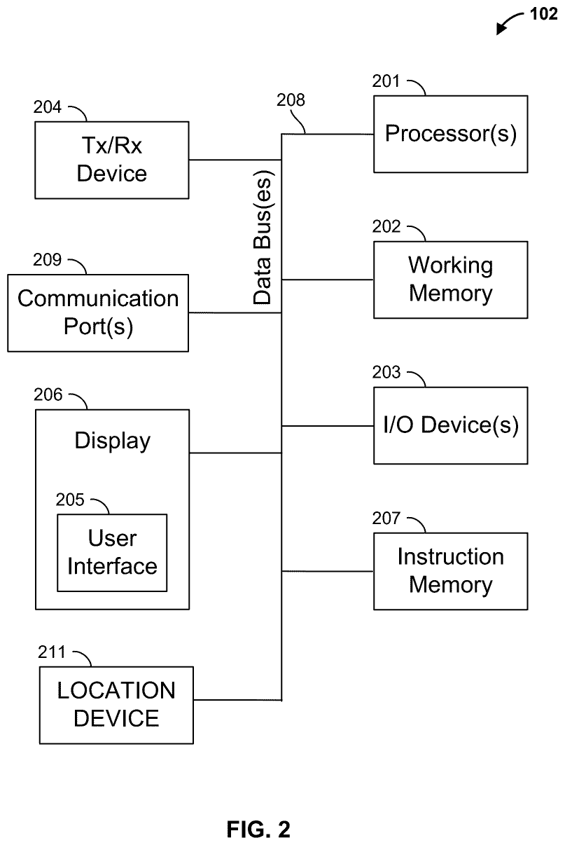

FIG. 2 illustrates a block diagram of a sales forecast computing device, e.g. the sales forecast computing device 102 of FIG. 1, in accordance with some embodiments of the present teaching. In some embodiments, each of the sales forecast computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the sales forecast computing device 102 can be combined, omitted, and/or replicated. In addition, it will be appreciated that additional elements other than those illustrated in FIG. 2 can be added to the sales forecast computing device 102.

As shown in FIG. 2, the sales forecast computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the sales forecast computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the sales forecast computing device 102 can include a single memory unit configured to operate as both instruction memory and working memory. Further, although embodiments are discussed herein including non-volatile memory, it will be appreciated that the sales forecast computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the sales forecast computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the sales forecast computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the sales forecast computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the sales forecast computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the sales forecast computing device 102 may determine a local geographical area (e.g., town, city, state, etc.) of its position.

In some embodiments, the sales forecast computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

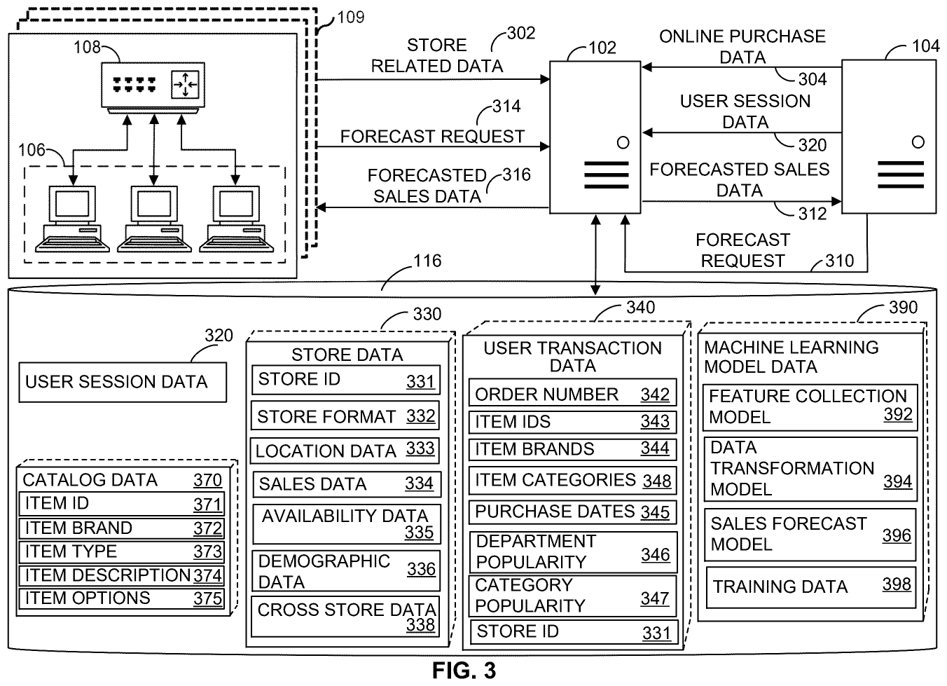

FIG. 3 is a block diagram illustrating various portions of a system for forecasting sales data of items that are new or missing historical sales data at a physical retailer store, e.g. the system shown in the network environment 100 of FIG. 1, in accordance with some embodiments of the present teaching. As indicated in FIG. 3, the sales forecast computing device 102 may receive user session data 320 from the server 104, and store the user session data 320 in the database 116. The user session data 320 may identify, for each user (e.g., customer or manager), data related to that user's browsing session, such as when browsing a retailer's webpage or API hosted by the server 104.

The sales forecast computing device 102 may also receive online purchase data 304 from the server 104, which identifies and characterizes one or more online purchases, such as purchases made by the user and other users via a retailer's website hosted by the server 104. The sales forecast computing device 102 may also receive store related data 302 from the one or more stores 109, which identifies and characterizes one or more in-store purchases. In some embodiments, the store related data 302 may also indicate other information about the one or more stores 109.

The sales forecast computing device 102 may parse the store related data 302 and the online purchase data 304 to generate store data 330 and user transaction data 340. In this example, the store data 330 may include, for each store, one or more of: a store ID 331 of the store, a store format 332 identifying a format of the store (e.g. supercenter, neighborhood market, divisional store, health and wellness, e-commerce, etc.), location data 333 identifying location information of the store (state name, city name, zip code, etc.), sales data 334 identifying historical sales for items in the store, availability data 335 identifying item availability in the store (e.g. shelf presence, etc.), demographic data 336 identifying demographics of the people shopping in the store and purchasing items in the store, and cross store data 338 indicating data related to multiple stores (e.g. a distance between two stores, shelf space ratio for a same item at two stores, etc.). In this example, the user transaction data 340 may include, for each purchase, one or more of: an order number 342 identifying a purchase order, item IDs 343 identifying one or more items purchased in the purchase order, item brands 344 identifying a brand for each item purchased, item categories 348 identifying a product type (or category) of each item purchased, purchase dates 345 identifying the purchase dates of the purchase orders, department popularity data 346 identifying popularity of a department to which transacted items belong, category popularity data 347 identifying popularity of a category to which transacted items belong, and store ID 331 for the corresponding in-store purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as item shelf, description, use or brand names, or any other suitable description), and item options 375 (e.g., item colors, sizes, flavors, etc.).

The database 116 may also store machine learning model data 390 identifying and characterizing one or more models and related data for forecasting sales data of items that are new or missing historical sales data at a physical retailer store. For example, the machine learning model data 390 may include: a feature collection model 392, a data transformation model 394, a sales forecast model 396, and training data 398.

The feature collection model 392 in this example can be used to collect different features related to items, stores, sales, availability. The feature collection model 392 may be a machine learning model developed based on diverse datasets. For example, the feature collection model 392 may be developed by leveraging hierarchical, geographical, and linear/non-linear relationships in diverse datasets at different locations, to automatically collect these datasets for sales data forecast.

The data transformation model 394 in this example can be used to transform different datasets for fitting the sales forecast model 396. For example, when the datasets and features collected by the feature collection model 392 are in different formats, the data transformation model 394 may perform data scaling and transformation (e.g. by conversion of data into correct NumPy shapes) to generate input data in a consistent format fitting the sales forecast model 396.

The sales forecast model 396 can be used to forecast estimated sales data for an NTS item at a store in a future time period. The NTS item has no or missing historical sales data at the store. In some examples, the sales forecast model 396 includes a hierarchical feed forward deep neural network that can learn both store-item interactions and sales interactions. In some examples, the sales forecast model 396 may be trained based on training data, which may include actual observed sales data of an item at a store during a past time period and/or synthetic sales data generated based on the actual sales data. In some examples, the sales forecast model 396 may be trained to minimize a mean squared error (MSE) reconstruction loss with weights and hyperparameters updated through back propagation.

The training data 398 may include data utilized for training one or more of the feature collection model 392, the data transformation model 394, and the sales forecast model 396. In some examples, the training data 398 may be formed based on: actual sales data of some items at stores during a past time period, and/or synthetic sales data generated based on the actual sales data. In some examples, the training data 398 comprises data related to different features collected by the feature collection model 392.

In some examples, the training data 398 is updated based on updated sales data and/or at least one key predictor of interest. In some embodiments, the machine learning model data 390 includes any number of the feature collection model(s) 392, the data transformation model(s) 394, and the sales forecast model(s) 396.

In some examples, the sales forecast computing device 102 receives a forecast request 310 from the server 104. The forecast request 310 may seek forecasted sales data 312 of an NTS item at a store in a future time period. In some examples, the forecast request 310 is triggered by an associate of a retailer, and the forecasted sales data 312 is provided to the retailer associate to determine whether to introduce the NTS item to the store.

In some embodiments, the sales forecast computing device 102 may determine at least one relevant feature related to the item or the store based on the forecast request, e.g. based on the feature collection model 392 and the data transformation model 394. Then, the sales forecast computing device 102 can compute forecasted sales data 312 of the item at the store in the future time period, e.g. based on the sales forecast model 396. In response to the forecast request 310, the sales forecast computing device 102 transmits the forecasted sales data 312 to the server 104.

In some embodiments, the sales forecast computing device 102 may assign one or more of the above described operations to a different processing unit or virtual machine hosted by one or more processing devices 120. Further, the sales forecast computing device 102 may obtain the outputs of the these assigned operations from the processing units, and generate the forecasted sales data 312 based on the outputs.

In some embodiments, a forecast request 314 may be transmitted from a store, e.g. the one or more stores 109, to seek forecasted sales data 316 of an NTS item at the store in a future time period. In some examples, the forecast request 314 is triggered by a merchant, and the forecasted sales data 316 is generated by the sales forecast computing device 102 in a similar manner to the forecasted sales data 312 and provided to the merchant to determine whether to introduce the NTS item to the store or for general assortment refresh of the store.

In some embodiments, the sales forecast computing device 102 may automatically update the forecasted sales data 312. For example, based on a configuration, an update request, or a predetermined periodic time interval, the sales forecast computing device 102 can collect updated relevant features and run the sales forecast model 396 again to generate updated forecasted sales data.

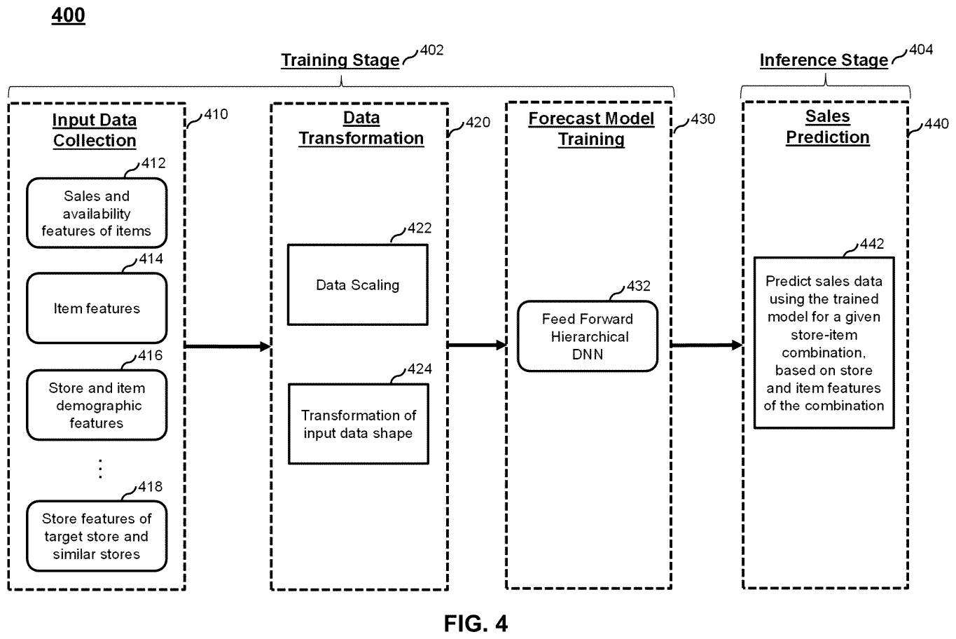

FIG. 4 illustrates an exemplary process 400 for training and using a sales forecast model, e.g. the sales forecast model 396 in FIG. 3, in accordance with some embodiments of the present teaching. In some embodiments, the process 400 can be carried out by one or more computing devices, such as the sales forecast computing device 102, and/or the cloud-based engine 121 of FIG. 1.

As shown in FIG. 4, the process 400 includes two stages: a training stage 402 of the sales forecast model and an inference stage 404 of the sales forecast model. As shown in FIG. 4, the training stage 402 includes operations of: input data collection 410, data transformation 420 and forecast model training 430.

The input data collection 410 may be performed to collect various features related to items, stores, sales and availability, e.g. by the feature collection model 392 in FIG. 3. In some examples, the collected features include sales and availability features 412 of items. The items in the training stage include: items that were new (NTS items) to a store some time ago and then offered for sale in the store for a time period. The real sales data of these items after being introduced to the store can be used as labelled data in a training dataset for training the sales forecast model. In some examples, the sales and availability features 412 may include: weekly sales data of each of the items, and availability data of each item in the store where it was being sold in each corresponding week.

In some examples, the collected features also include item features 414 of the items. The item features 414 may include descriptive features of the items, e.g. brand name, product hierarchy, product name, product type, primary shelf, item description, catalog identity (ID), merchandise department, merchandise category, etc.

In some examples, the collected features also include store and item demographic features 416. The store and item demographic features 416 may include item demographic data indicating e.g. demographics of customers who bought the item. The store and item demographic features 416 may also include store demographic data indicating e.g. demographics of customers who usually shop at stores (including a target store and stores similar to the target store) where the item was sold. In some embodiments, the demographics are based on a percentage of house hold popularity across ethnic groups and across people generations.

In some examples, the collected features also include store features 418 of target store and similar stores. The store features 418 may include features related to the store data 330 in the database 116. In some embodiments, for a given target store where an NTS item is introduced, the system selects a plurality of top similar stores (e.g. top ten similar stores) to the target store, and utilizes the sales data of the NTS item within these top similar stores as part of the input data to the sales forecast model. As such, even if there is no historical sales data for the NTS item at the target store, a sales forecast can still be performed for the NTS item at the target store for a future time period.

In some embodiments, the plurality of similar stores are determined based on: obtaining store features of the target store and a plurality of candidate physical stores; computing, for each respective store feature, a feature match score indicating a matching degree of the respective store feature between the target store and each candidate physical store; computing, for each candidate physical store, a weighted match score based on a weighted average of the feature match scores for all store features between the target store and the candidate physical store with predetermined weights; ranking the plurality of candidate physical stores based on their respective weighted match scores to generate a ranked list; and determining top ranked candidate physical stores in the ranked list as the plurality of similar stores. In some examples, the store features comprise: a store format description, a state name, a city name, a distance between two stores, and a shelf space ratio of the item between the two stores. In some examples, all feature match scores are normalized to values between 0 and 1 before being combined to compute the weighted match score.

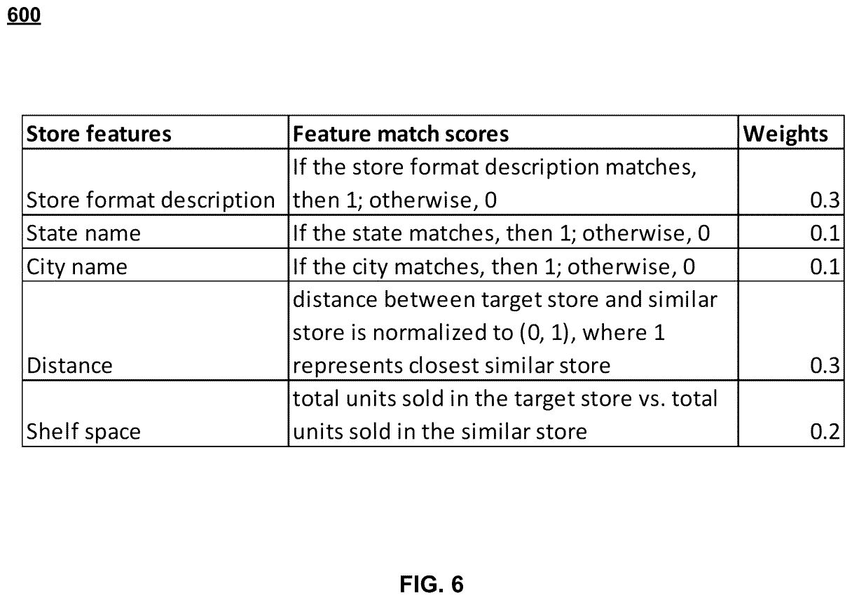

FIG. 6 shows a table 600 illustrating exemplary features for determining similar stores, in accordance with some embodiments of the present teaching. As shown in the table 600, the store features used for determining similar stores include: store format description, state name, city name, distance, and shelf space. Each of these store features may be used to compute a feature match score between the target store and each candidate store, to indicate a similarity associated with this store feature between the target store and the candidate store.

In some examples, the store format description can take possible values of: supercenter, neighborhood market, divisional store, health and wellness, e-commerce, etc., to describe a format of the target store and each candidate store. For each candidate store, if the store format descriptions of the target store and the candidate store match each other, the corresponding feature match score is equal to 1. Otherwise, if the store format descriptions of the target store and the candidate store do not match each other, the feature match score is equal to 0.

In some examples, the state name can take possible values of any U.S. state, to indicate a state where each of the target store and the candidate stores is located. For each candidate store, if the states of the target store and the candidate store match each other, the corresponding feature match score is equal to 1. Otherwise, if the states of the target store and the candidate store do not match each other, the corresponding feature match score is equal to 0.

In some examples, the city name can take possible values of any U.S. city, to indicate a city where each of the target store and the candidate stores is located. For each candidate store, if the cities of the target store and the candidate store match each other, the corresponding feature match score is equal to 1. Otherwise, if the cities of the target store and the candidate store do not match each other, the corresponding feature match score is equal to 0.

In some examples, the distance feature indicates a distance between the target store and each candidate store. For each candidate store, the distance between the target store and the candidate store is normalized to a value between 0 and 1 as the corresponding feature match score, where 1 represents a closest distance and 0 represents a farthest distance.

In some examples, the shelf space feature indicates a department level shelf space (e.g. in terms of unit area assigned to each department within a store) allocated to each department at each of the target store and the candidate stores. For each candidate store, the corresponding feature match score is computed based on a ratio between the shelf space allocated in the target store for the department in which the item belongs to divided by the shelf space allocated in the candidate store for the department in which the item belongs to. In some embodiments, the corresponding feature match score for the shelf space feature is also normalized to be a value between 0 and 1, where 1 represents a that target and candidate store have a similar shelf space for the department and 0 represents a most different shelf space between target and candidate store.

For each candidate store, the corresponding feature match scores for all of the store features regarding the target store can be combined to compute a weighted average match score, e.g. based on the weights listed in the table 600. Then, the candidate stores can be ranked according to their respective weighted average match scores to generate a ranked list, where a higher weighted average match score indicates a more similar store to the target score and makes the corresponding candidate store ranked higher in the ranked list. The top ranked stores in the ranked list will be selected as the top similar stores to the target store. For example, 10 top similar stores may be selected from 500 candidate stores for the target store.

In some embodiments, additional store features related to assortment awareness may be considered as well to compute the average availability of substitutes in the target and candidate stores. For example, availability features of substitute items for the target item at each candidate store may be utilized to compute a corresponding substitute availability score.

Referring back to FIG. 4, the input data collection 410 may be performed to create a training dataset using the item-store combinations that have been historically NTS. As discussed above, the features used to create the training dataset may include: sales of the NTS item across top similar stores (e.g. top 10 similar stores) based on the NTS item availability for a past time period (e.g. past 104 weeks) across all the stores where the NTS item was previously sold; availability of the NTS item across top similar stores (e.g. top 10 similar stores) based on the NTS item availability for the past time period (e.g. past 104 weeks) across all the stores where the NTS item was previously sold; features of the target store and the top similar stores (e.g. top 10 similar stores); department category traffic; item features; NTS department category; NTS item introduction week; NTS item and target store demographic features; NTS item category and subcategory; and fine line penetration scores.

The training dataset may be automatically passed to perform the data transformation 420, which includes a data scaling 422 and a transformation 424 of input data shape. In some examples, the data scaling 422 may be performed based on a min-max scaling on the features in the training dataset, to normalize the features and ensure a correct and fast converge during model training.

In some examples, the transformation 424 may be performed to transform all features in the training dataset to a correct vector shape as an input tensor compatible to be passed into the sales forecast model. In some embodiments, the sales forecast model is a feed forward deep neural network that only accepts certain input formats.

After the data transformation 420, a transformed training dataset is created and passed to perform forecast model training 430. In the example shown in FIG. 4, a feed forward hierarchical deep neural network (DNN) 432 is trained across all these historical rollup store combinations based on the transformed training dataset, as the sales forecast model, e.g. the sales forecast model 396 in FIG. 3.

At the inference stage 404, a sales prediction 440 is performed based on the trained sales forecast model. In some examples, at operation 442, sales data (e.g. weekly sales) is predicted using the trained model for a new store-item combination in a future time period, based on store, item and sales features of the store-item combination (and similar stores).

In some embodiments, the sales forecast model may be re-trained based on updated training dataset in the training stage 402, before or after the inference stage 404. In some embodiments, to predict sales data for multiple items, their relevant features can be passed in a batch to the sales forecast model during the inference stage 404, where the forecasted sales data for the items are generated respectively by the sales forecast model.

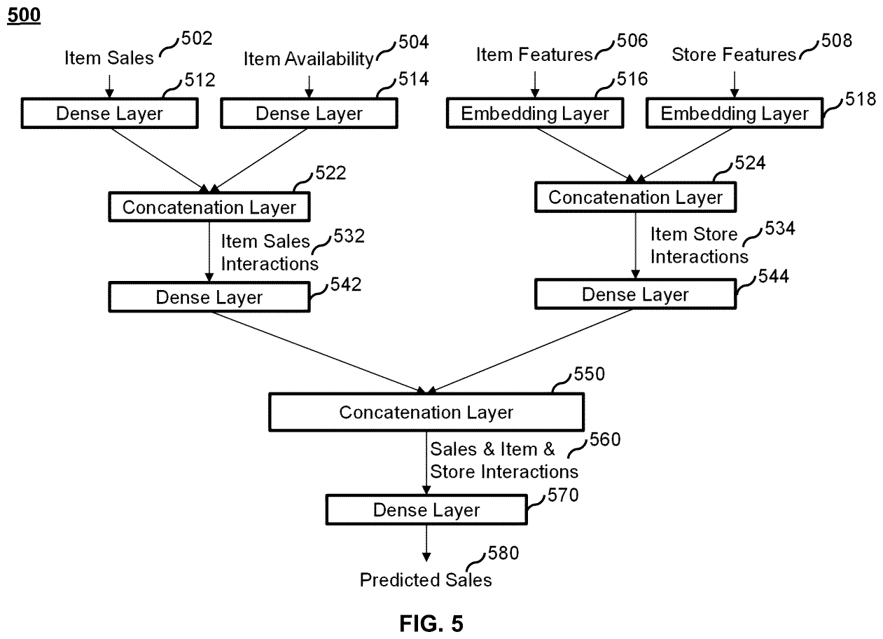

FIG. 5 illustrates an exemplary structure 500 of a sales forecast model, e.g. the sales forecast model 396 in FIG. 3 or the feed forward hierarchical DNN 432 in FIG. 4, in accordance with some embodiments of the present teaching. In some embodiments, the structure 500 indicates a process that can be carried out by one or more computing devices, such as the sales forecast computing device 102, and/or the cloud-based engine 121 of FIG. 1. The process may be performed during either a training stage or an inference stage of the sales forecast model.

In the example shown in FIG. 5, the structure 500 of the sales forecast model includes: dense layers 512, 514, embedding layers 516, 518, a plurality of concatenation layers 522, 524, 550, and a plurality of dense layers 542, 544, 570. As shown in FIG. 5, the layers are in different hierarchies and depths to form a hierarchical structure of the sales forecast model. In some examples, each layer shown in FIG. 5 may be formed by multiple sub-layers. For example, each of the dense layers 542, 544, 570 may comprise multiple dense sub-layers.

In some embodiments, during a training stage of the sales forecast model, a training dataset is generated or obtained. The training dataset may include labelled sales data and training features related to a set of items and a set of stores. In the example shown in FIG. 5, the training features may comprise: item sales features 502, item availability features 504, item features 506 and store features 508.

As shown in FIG. 5, the item sales features 502 and the item availability features 504 are passed through dense layers 512, 514, respectively, and are concatenated by a first concatenation layer 522 to generate a concatenated output indicating item sales interactions 532, which may then be passed through a first dense layer 542 to learn first interaction information related to item sales.

In parallel to the first interaction information generation, the item features 506 and the store features 508 are passed through embedding layers 516, 518, respectively, to generate a high-dimensional embedding vector for each of these features. These embedding vectors are passed to a second concatenation layer 524 to concatenate the embedding features to a concatenated output indicating item store interactions 534, which may then be passed through a second dense layer 544 to learn second interaction information related to item and store features.

As shown in FIG. 5, the first interaction information and the second interaction information can be merged or concatenated through a third concatenation layer 550, to generate a merged output indicating sales, item and store interactions 560, which may be passed through a third dense layer 570 to generate predicted sales data 580.

During a training stage of the sales forecast model, the model is trained based on a minimization of a mean squared error (MSE) between the predicted sales data and the labelled sales data. In some examples, the labelled sales data is determined based on historical sales data of the set of items. In some examples, training the sales forecast model comprises: updating weights and hyperparameters of the sales forecast model based on back propagation and validating the sales forecast model based on a minimization of a weighted mean absolute percentage error (WMAPE).

In some examples, the MSE can be expressed as:

$$MSE = \frac{1}{n} {\sum }_{i = 1}^{n} {( {\hat{Y}}_{i} - {Y}_{i} )}^{2} , \qquad ( 1 )$$

where Yi represents actual observed sales of the NTS item i in 52 weeks in the target store, Yi(hat) represents model predicted sales of the NTS item i in 52 weeks in the target store.

In some examples, the back propagation for weight update can be expressed as:

$$\frac{\partial C}{\partial {a}^{( L - 1 )}} = \frac{\partial {z}^{( L )}}{\partial {a}^{( L - 1 )}} \frac{\partial {a}^{( L )}}{\partial {z}^{( L )}} \frac{\partial C}{\partial {a}^{( L )}} , \qquad ( 2 )$$

where the left hand side of equation (2) represents a new model weight in current iteration, and the right hand side of equation (2) represents a change of weight with respect to loss in last iteration.

In some examples, the WMAPE can be expressed as:

$$Sum ( Actual \times \sum ( \vert Actual - Forecasted \vert ) \times 100 / \vert Actual \vert ) / Sum ( Actual ) , \qquad ( 3 )$$

where Actual and Forecasted represent actual sales and forecasted sales, respectively.

In some embodiments, the item features 506 may comprise demand transfer coefficients each representing an anticipated amount of demand transferred from a target item to a respective substitute item of substitute items when the substitute item is introduced to a store. In some embodiments, the item availability features 504 may comprise availability of the substitute items in the set of stores.

In some embodiments, additional features (e.g. seasonality features of the future time period, target item introduction week, post introduction target item availability, availability of substitute items in the assortment, etc.) can be collected, embedded and learned to generate the predicted sales data 580. For example, embeddings of one or more of the additional features may be directly passed through the dense layer 570 together with the sales, item and store interactions 560, to generate the predicted sales data 580.

As shown in FIG. 5, the sales forecast model has a hierarchical structure with one input side learning from the sales and availability features and the other side learning from the item and store features. This structure 500 of the sales forecast model enables a non-zero sales prediction even in case of receiving a sparse input sales vector for an item whose historical sales data at a target store is not available. In various embodiments, the historical sales data of the item at the target store is not available because of at least one of the following reasons; the item is a low velocity item having very sparse sales; the item was never offered for sale at the target store; the item was not offered for sale at the target store during a predetermined past time period; the historical sales data is missing; or the historical sales data is confidential or inaccessible.

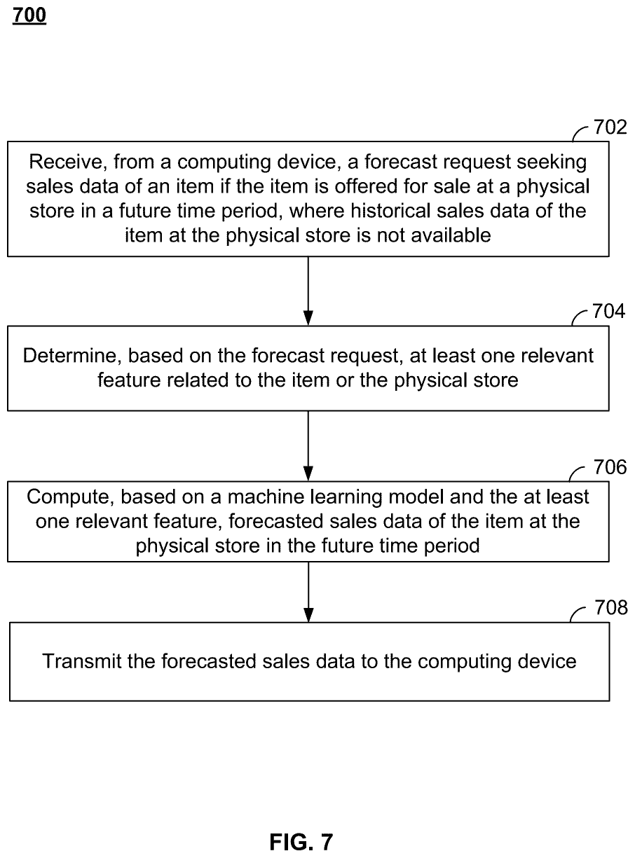

FIG. 7 is a flowchart illustrating an exemplary method 700 for forecasting sales data of items that are new or missing historical sales data, in accordance with some embodiments of the present teaching. In some embodiments, the method 700 can be carried out by one or more computing devices, such as the sales forecast computing device 102 and/or the cloud-based engine 121 of FIG. 1. Beginning at operation 702, a forecast request is received from a computing device, seeking sales data of an item if the item is offered for sale at a physical store in a future time period. Historical sales data of the item at the physical store is not available. At operation 704, at least one relevant feature related to the item or the physical store is determined based on the forecast request. At operation 706, based on a machine learning model and the at least one relevant feature, forecasted sales data is computed for the item at the physical store in the future time period. The forecasted sales data is transmitted at operation 708 to the computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, a forecast request seeking sales data of an item if the item is offered for sale at a physical store in a future time period, wherein historical sales data of the item at the physical store is not available,
determine, based on the forecast request, at least one relevant feature related to the item or the physical store,
compute, based on a machine learning model and the at least one relevant feature, forecasted sales data of the item at the physical store in the future time period, and
transmit the forecasted sales data to the computing device.

2. The system of claim 1, wherein the historical sales data of the item at the physical store is not available because of at least one of the following reasons:
the item was never offered for sale at the physical store;
the item was not offered for sale at the physical store during a predetermined past time period;
the historical sales data is missing; or
the historical sales data is confidential or inaccessible.

3. The system of claim 1, wherein the at least one relevant feature comprises one or more of the following features:
historical sales data and historical availability data of the item at a plurality of similar physical stores that are similar to the physical store;
item related features of the item;
store related features of the physical store and the plurality of similar physical stores;
demographic features of the item;
demographic features of the physical store and the plurality of similar physical stores; and
seasonality features of the future time period.

4. The system of claim 3, wherein the item related features comprise at least one of:
a product name of the item;
a brand name of the item;
an item level description of the item;
a product hierarchy description of the item;
a catalog identity (ID) of the item;
a merchandise department of the item; or
a merchandise category of the item.

5. The system of claim 3, wherein the plurality of similar physical stores are determined based on:
obtaining store features of the physical store and a plurality of candidate physical stores;
computing, for each respective store feature, a feature match score indicating a matching degree of the respective store feature between the physical store and each candidate physical store;
computing, for each candidate physical store, a weighted match score based on a weighted average of the feature match scores for all store features between the physical store and the candidate physical store with predetermined weights;
ranking the plurality of candidate physical stores based on their respective weighted match scores to generate a ranked list; and
determining top ranked candidate physical stores in the ranked list as the plurality of similar physical stores.

6. The system of claim 5, wherein:
the store features comprise: a store format description, a state name, a city name, a distance between two stores, and a shelf space ratio of the item between the two stores; and
all feature match scores are normalized to values between 0 and 1 before being combined to compute the weighted match score.

7. The system of claim 1, wherein the machine learning model is a hierarchical feed-forward deep neural network (DNN) trained based on:
obtaining a training dataset including labelled sales data and training features related to a set of items and a set of stores, wherein the training features comprise: sales features, availability features, item features and store features;
passing the sales features and the availability features through embedding layers, a first concatenation layer and a first dense layer of the DNN to learn first interaction information related to item sales;
passing the item features and the store features through embedding layers, a second concatenation layer and a second dense layer of the DNN to learn second interaction information related to item and store features;
merging the first interaction information and the second interaction information through a third concatenation layer and a third dense layer of the DNN to generate predicted sales data; and
training the DNN based on a minimization of a mean squared error between the predicted sales data and the labelled sales data.

8. The system of claim 7, wherein:
the labelled sales data is determined based on historical sales data of the set of items; and
training the DNN comprises: updating weights and hyperparameters of the DNN based on backpropagation and a minimization of a weighted mean absolute percentage error.

9. The system of claim 7, wherein:
the item features comprise demand transfer coefficients each representing an anticipated amount of demand transferred from a target item to a respective substitute item of substitute items when the substitute item is introduced to a store; and
the availability features comprise availability of the substitute items in the set of stores.

10. The system of claim 1, wherein the at least one processor is configured to:
generate, based on the forecasted sales data, recommended assortment data for the physical store in the future time period; and
transmit the recommended assortment data to the computing device for assortment refresh at the physical store, wherein both the forecasted sales data and the recommended assortment data are visually presented to a manager of the physical store.

11. A computer-implemented method, comprising:
receiving, from a computing device, a forecast request seeking sales data of an item if the item is offered for sale at a physical store in a future time period, wherein historical sales data of the item at the physical store is not available;
determining, based on the forecast request, at least one relevant feature related to the item or the physical store;
computing, based on a machine learning model and the at least one relevant feature, forecasted sales data of the item at the physical store in the future time period; and
transmitting the forecasted sales data to the computing device.

12. The computer-implemented method of claim 11, wherein the historical sales data of the item at the physical store is not available because of at least one of the following reasons:
the item was never offered for sale at the physical store;
the item was not offered for sale at the physical store during a predetermined past time period;
the historical sales data is missing; or
the historical sales data is confidential or inaccessible.

13. The computer-implemented method of claim 11, wherein the at least one relevant feature comprises one or more of the following features:
historical sales data and historical availability data of the item at a plurality of similar physical stores that are similar to the physical store;
item related features of the item;
store related features of the physical store and the plurality of similar physical stores;
demographic features of the item;
demographic features of the physical store and the plurality of similar physical stores; and
seasonality features of the future time period.

14. The computer-implemented method of claim 13, wherein the item related features comprise at least one of:
a product name of the item;
a brand name of the item;
an item level description of the item;
a product hierarchy description of the item;
a catalog identity (ID) of the item;
a merchandise department of the item; or
a merchandise category of the item.

15. The computer-implemented method of claim 13, wherein the plurality of similar physical stores are determined based on:
obtaining store features of the physical store and a plurality of candidate physical stores;
computing, for each respective store feature, a feature match score indicating a matching degree of the respective store feature between the physical store and each candidate physical store;
computing, for each candidate physical store, a weighted match score based on a weighted average of the feature match scores for all store features between the physical store and the candidate physical store with predetermined weights;
ranking the plurality of candidate physical stores based on their respective weighted match scores to generate a ranked list; and
determining top ranked candidate physical stores in the ranked list as the plurality of similar physical stores.

16. The computer-implemented method of claim 15, wherein:
the store features comprise: a store format description, a state name, a city name, a distance between two stores, and a shelf space ratio of the item between the two stores; and
all feature match scores are normalized to values between 0 and 1 before being combined to compute the weighted match score.

17. The computer-implemented method of claim 11, wherein the machine learning model is a hierarchical feed-forward deep neural network (DNN) trained based on:
obtaining a training dataset including labelled sales data and training features related to a set of items and a set of stores, wherein the training features comprise: sales features, availability features, item features and store features;
passing the sales features and the availability features through embedding layers, a first concatenation layer and a first dense layer of the DNN to learn first interaction information related to item sales;
passing the item features and the store features through embedding layers, a second concatenation layer and a second dense layer of the DNN to learn second interaction information related to item and store features;
merging the first interaction information and the second interaction information through a third concatenation layer and a third dense layer of the DNN to generate predicted sales data; and
training the DNN based on a minimization of a mean squared error between the predicted sales data and the labelled sales data.

18. The computer-implemented method of claim 17, wherein:
the labelled sales data is determined based on historical sales data of the set of items;
training the DNN comprises: updating weights and hyperparameters of the DNN based on backpropagation and a minimization of a weighted mean absolute percentage error;
the item features comprise demand transfer coefficients each representing an anticipated amount of demand transferred from a target item to a respective substitute item of substitute items when the substitute item is introduced to a store; and
the availability features comprise availability of the substitute items in the set of stores.

19. The computer-implemented method of claim 11, further comprising:
generate, based on the forecasted sales data, recommended assortment data for the physical store in the future time period; and
transmit the recommended assortment data to the computing device for assortment refresh at the physical store, wherein both the forecasted sales data and the recommended assortment data are visually presented to a manager of the physical store.

20. A non-transitory computer readable medium having instructions stored thereon, wherein the instructions, when executed by at least one processor, cause at least one device to perform operations comprising:
receiving, from a computing device, a forecast request seeking sales data of an item if the item is offered for sale at a physical store in a future time period, wherein historical sales data of the item at the physical store is not available;
determining, based on the forecast request, at least one relevant feature related to the item or the physical store;
computing, based on a machine learning model and the at least one relevant feature, forecasted sales data of the item at the physical store in the future time period; and
transmitting the forecasted sales data to the computing device.
